(19) United States
(12) Patent Application Publication
(10) Pub. No.: US 2010/0270903 A1
(43) Pub. Date: Oct. 28, 2010

(54) LIGHT-EMITTING DIODE (LED) RECESSED LIGHTING LAMP

(75) Inventors: Chen-Chi JAO, Toufen Town (TW); Chic-Wei LIN, Zhonghe City (TW)

Correspondence Address: EGBERT LAW OFFICES, 412 MAIN STREET, 7TH FLOOR, HOUSTON, TX, 77002, US

(73) Assignee: ECOMAA LIGHTING, Inc., Zhubei City (TW)

(21) Appl. No.: 12/429,089

(22) Filed: Apr. 23, 2009

(51) Int. Cl. H01J 7/24

(52) U.S. Cl. 313/46

(57) ABSTRACT

The present invention provides a light emitting diode LED recessed lighting lamp. The lamp includes a base with a LED assembly surface and a circumferential assembly stop flange shaped around the base for mating with the LED assembly surface. The LED assembly surface is provided with a circuit hole. There is an LED assembly, containing a printed circuit board PCB, a plurality of LED units and electric wire. The back of PCB is assembled securely onto the LED assembly surface of the base. The electric wire penetrates the circuit hole of the LED assembly surface and extends towards the second end of the base. A diffuser externally covers onto the LED assembly surface of the base. A heat-radiating base contains a heat-radiating portion with expanded area. There is an assembly locating member, assembled laterally on the second end of the base.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a lighting, and more particularly to an innovative recessed light-emitting diode (LED) lighting lamp.

2. Description of Related Art Including Information Disclosed Under 37 CFR 1.97 and 37 CFR 1.98.

Recessed lighting lamps are commonly used as the people put more focus on decorations in the living or business space. Since the main bodies of recessed lighting lamps are generally embedded into the ceilings, the recessed lighting lamps are more aesthetically pleasing, and also more suitable for creating a comfortable and harmonious atmosphere due to the radiative pattern unlike the fluorescent lamps.

However, there are structural disadvantages of the typical recessed lighting lamps. For example, there are excessive components requiring assembly and difficult installation in a space-saving manner due to limited depth and/or space. In the case of transverse beams or girders in ceilings, recessed lighting cannot be mounted in place due to insufficient space or height and have to be relocated against preset plans.

Despite of the fact that energy-saving LED recessed lighting lamps of simple construction are developed recently, the heat-radiating portions of LED recessed lighting lamps commercially available are designed imperfectly, leading possibly to overheating and shorter life cycles of the lamps. Hence, there is still room for improvement.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the uniqueness of the present invention, the LED recessed lighting lamp is composed of a base, LED assembly, diffuser, heat-radiating base and assembly locating member. The present invention features a very simple construction as compared to the prior art. Moreover, the heat-radiating base and the base can be integrally fabricated. The heat generated from the LED assembly is transferred via the LED assembly surface to the heat-radiating base, such that the heat-radiating portion can provide a satisfactory heat-radiation effect. Therefore, the present invention includes simple construction and excellent heat-radiation effect.

Furthermore, based on the structure of the LED assembly, the back of a printed circuit board (PCB) is assembled securely onto the LED assembly surface of the base. The thin-profile LED recessed lighting lamp of the present invention has no reflective cover, so the shortcomings of insufficient space and height in the ceiling could be resolved to ensure unobstructed assembly of the recessed lighting lamp.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the preferred embodiment of the present invention.

FIG. 2 shows an exploded perspective view of the preferred embodiment of the present invention.

FIG. 3 shows an assembled sectional view of the preferred embodiment of the present invention.

FIG. 4 shows a sectional view of the preferred embodiment of the combined heat-radiating base of the present invention.

FIG. 5 shows a sectional view of the assembled LED recessed lighting lamp of the present invention.

FIG. 6 shows a perspective view of the structure of another preferred embodiment of the assembly locating member of the present invention.

FIG. 7 shows a partial sectional view of the structure of another preferred embodiment of the assembly locating member of the present invention.

FIG. 8 shows another partial elevation view of another preferred embodiment of the assembly locating member of the present invention.

FIG. 9 shows a perspective view of the heat-radiating base of the present invention.

FIG. 10 shows another perspective view of the heat-radiating base of the present invention.

### DETAILED DESCRIPTION OF THE INVENTION

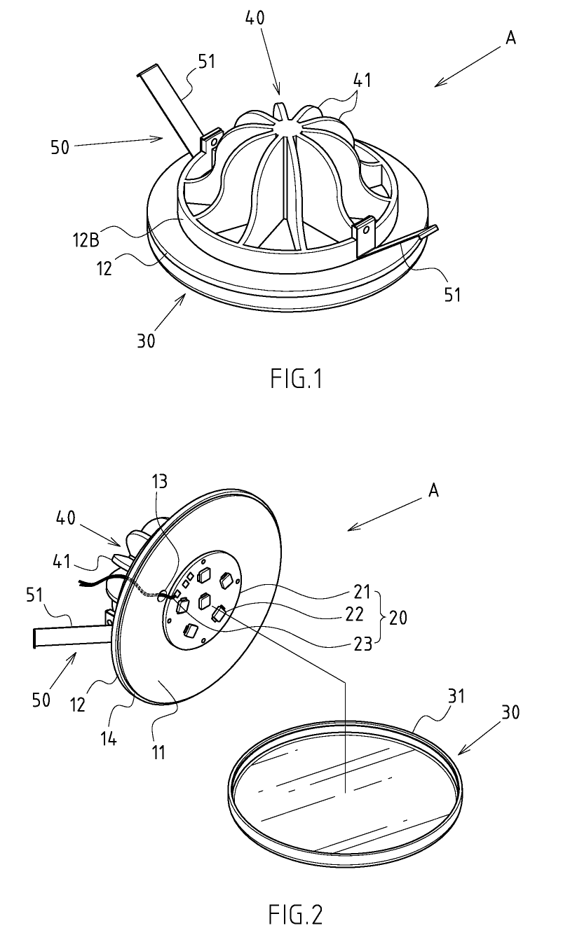

FIGS. 1-3 depict preferred embodiments of an LED recessed lighting lamp of the present invention. The embodiments are provided for only explanatory purposes with respect to the patent claims.

The LED recessed lighting lamp A comprises a base 10, with a LED assembly surface 11 formed at its first end. The LED assembly surface 11 of the preferred embodiment is a flat surface. A circumferential assembly stop flange 12 and a longitudinal extending ring 12B are shaped around the base 10. Moreover, the circumferential assembly stop flange 12 is mated with the LED assembly surface 11 on a flat surface or a stepped surface. The LED assembly surface 11 is provided with a circuit hole 13 protruding from the second end of the base 10.

The lamp also includes a LED assembly 20, containing a PCB 21, a plurality of LED units 22 assembled onto the PCB 21 and a electric wire 23 for feeding power to the PCB 21. The back of PCB 21 is adhered securely onto the LED assembly surface 11 of the base 10, so that the heat generated from the LED assembly 20 is transferred directly via the LED assembly surface 11 to a heat-radiating base 40 at second end of the base 10. The electric wire 23 penetrates the circuit hole 13 of the LED assembly surface 11 and extends to the second end of the base 10.

There is a diffuser 30, which is covered externally onto the LED assembly surface 11 of the base 10, wherein the LED assembly 20 is accommodated.

There is a heat-radiating base 40, which is assembled and protruded on the second end of the base 10. The heat-radiating base 40 contains heat-radiating portion 41 with expanded area.

An assembly locating member 50 is assembled on the second end of the base 10 adjacent to the circumferential assembly stop flange 12 or longitudinal extending ring 12B.

A circular shoulder 14 is formed around the LED assembly surface 11 of the base 10. A mating flange 31 is formed on the assembly end of the diffuser 30 for tightly sleeving and positioning onto the circular shoulder 14.

The heat-radiating portion 41 of the heat-radiating base 40 can be composed of multiple plates arranged at intervals. For example, the heat-radiating portion 41 referred in FIG. 1 is composed of multiple plates in radiative configuration.

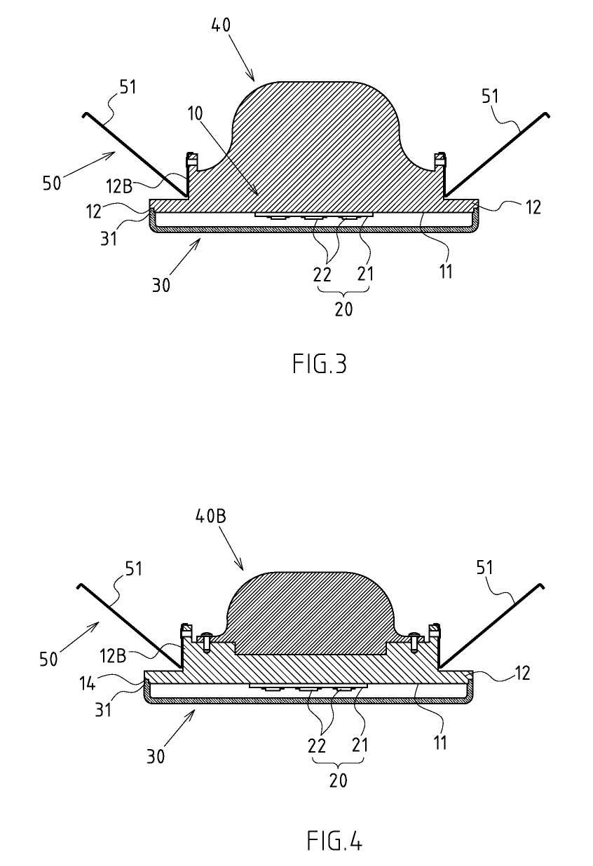

Referring to FIG. 3, the heat-radiating base 40 can protrude from the second end of the base 10. The base 10 of the preferred embodiment along with the heat-radiating base 40 is made of metal materials of excellent heat conductivity. The heat generated from LED assembly 20 will be transferred to the heat-radiating base 40 through the LED assembly surface 11 of the base 10, realizing efficient heat-radiation via the heat-radiating portion 41.

Referring also to FIG. 4, the heat-radiating base 40B of the preferred embodiment is separately fabricated and adhered onto the second end of the base 10. So, an equivalent heat-radiation effect can be realized with the integrated heat-radiating base 40B.

The assembly locating member 50 is of many structural patterns. Referring to FIGS. 1-3, the assembly locating member 50 is composed of two sets of oblique clips 51 arranged in 180°. These two sets of oblique clips 51 are protruded obliquely towards the second end of the base 10. With this structure, these two sets of oblique clips 51 enable the LED recessed lighting lamp A to be positioned in combination with circumferential assembly stop flange 12 of the base 10.

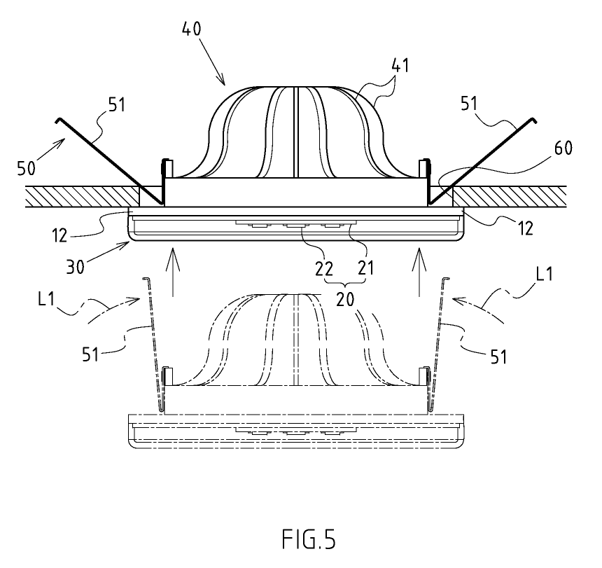

Referring to FIG. 5, when the LED recessed lighting lamp A is to be assembled into the mounting hole 60 on the ceiling, these two sets of oblique clips 51 pulled inwards (shown by arrow L1), such that the oblique clips 51 are locked onto inner wall of the mounting hole 60 after passing through it, and then abutted onto external wall of the mounting hole 60 in combination with the circumferential assembly stop flange 12 of the base 10, thus realizing the positioning of the LED recessed lighting lamp A.

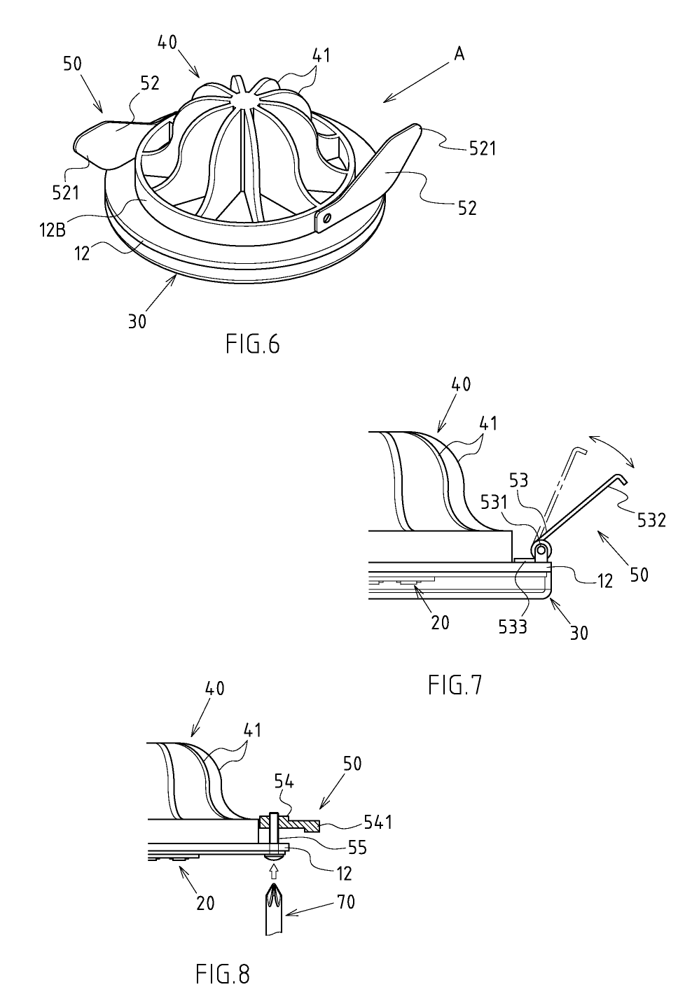

Referring to FIG. 6, the assembly locating member 50 can also be made of a plurality of lateral clips 52 with laterally extended swinging ends 521. The swinging end 521 is normally protruded from the circumferential assembly stop flange 12 of the base 10, and also recessed into assembly stop flange 12 under compression. The LED recessed lighting lamp A can also be positioned with the flexibility.

Referring to FIG. 7, the assembly locating member 50 can also be composed of a plurality of torsional springs 53, which comprise a pivotal portion 531, a springing end 532 and a reverse supporting end 533. The springing end 532 is protruded obliquely towards the second end of the base 10. When swinging towards the upper end as shown in the figure, the springing end 532 allows for resetting via the counteracting force of the reverse supporting end 533. The LED recessed lighting lamp A can also be positioned with the flexibility.

Referring to FIG.8, the assembly locating member 50 can be composed of a plurality of rotary buttons 54, which are arranged transversely, with the inner end screwed laterally onto the circumferential assembly stop flange 12 via a bolt 55. So, the rotary button 54 can be driven by a screwdriver 70, so as to control the outer end 541 of the rotary button 54 in an expanded or recessed state, thus realizing the positioning of the LED recessed lighting lamp A.

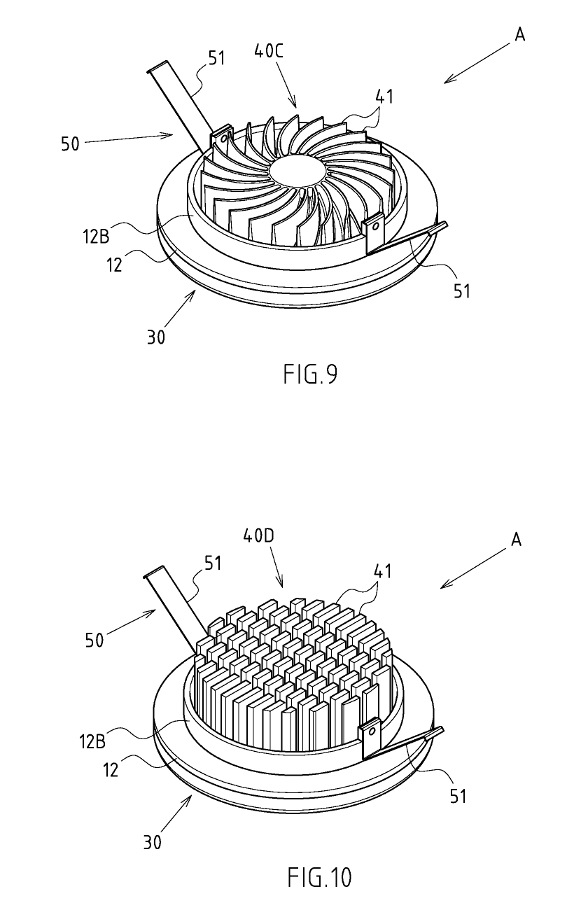

Referring to FIG. 9, the heat-radiating portion 41 of the heat-radiating base 40C is of an eddy pattern made of arched plates. Referring to FIG. 10, the heat-radiating portion 41 of the heat-radiating base 40D is of a rectangular pattern made of plain plates.

1. A light emitting diode LED recessed lighting lamp, comprising:
a base, with an LED assembly surface formed at first end; thereof, a circumferential assembly stop flange, and a longitudinal extending ring shaped around said base, said circumferential assembly stop flange being mated with the LED assembly surface, said LED assembly surface being provided with a circuit hole protruding from a second end of said base;
a LED assembly, having a printed circuit board PCB, a plurality of LED units assembled onto the PCB and a electric wire for feeding power to the PCB, the PCB having a back adhered securely onto the LED assembly surface of said base, so that the heat generated from the LED assembly is transferred directly via the LED assembly surface to a heat-radiating base at second end of the base, said electric wire penetrating a circuit hole of the LED assembly surface and extending towards the second end of the base;
a diffuser, covered externally onto the LED assembly surface of the base, wherein the LED assembly is accommodated;
a heat-radiating base, assembled and protruding from the second end of the base, said heat-radiating base having a heat-radiating portion with an expanded area; and
an assembly locating member, being assembled on the second end of the base adjacent to the circumferential assembly stop flange or longitudinal extending ring.

2. The lamp defined in claim 1, wherein a circular shoulder is formed around the LED assembly surface of the base, a mating flange being formed on the assembly end of the diffuser for tightly sleeving and positioning onto the circular shoulder.

3. The lamp defined in claim 1, wherein the LED assembly surface of the base is a flat surface, the LED assembly surface being mated with the circumferential assembly stop flange on a flat surface or a stepped surface

4. The lamp defined in claim 1, wherein the heat-radiating portion of the heat-radiating base is comprised of multiple plates arranged at intervals.

5. The lamp defined in claim 1, wherein the heat-radiating base protrudes from the second end of the base.

6. The lamp defined in claim 1, wherein the heat-radiating base is separately fabricated and then adhered onto the second end of the base.

7. The lamp defined in claim 1, wherein the assembly locating member is selected from a group of structural patterns consisting of: a plurality of oblique clips, a plurality of lateral clip, a plurality of torsional springs, and a plurality of rotary buttons.
